(19) United States
(12) Patent Application Publication
(10) Pub. No.: US 2015/0019681 A1
(43) Pub. Date: Jan. 15, 2015

(54) ACTIVE COMPUTER SERVICE SOLICITATION

(71) Applicant: Qualcomm Innovation Center, Inc., San Diego, CA (US)

(72) Inventor: Craig M. Dowell, Bellevue, WA (US)

(21) Appl. No.: 13/938,736

(22) Filed: Jul. 10, 2013

(51) Int. Cl. H04L 29/08

(52) U.S. Cl. CPC H04L 67/02
USPC 709/217

(57) ABSTRACT

An apparatus comprising a first computing device configured to provide a service to one or more additional computing devices. The first computing device is further configured to advertise the service as available to the one or more additional computing devices by creating and providing a data string relating to the first computing device service to the one or more additional computing devices prior to receiving a request for the services from the one or more additional computing devices.

### BACKGROUND OF THE INVENTION

1. Field of the Invention

This invention is related to advertising computer services. Specifically, but not intended to limit the invention, embodiments of the invention are related to allowing computer services to solicit clients prior to receiving a request from the clients by adding data to service advertisements issued from the computer hosting the service.

2. Relevant Background

A service provided by a computing device on a network to other computing devices on the network often advertises the existence of the service to the other computing devices by, for example, using a name server to map the service and identify the service with a particular protocol type and name. A client such as, but not limited to, a web browser or computing device application may discover the existence of the service by issuing a request for the service. Such a request may discover the service by querying the name server for connection information to the service and to determine which protocols are supported by the service.

Passive parameters of a provided service may be accessible when the name server is contacted and information regarding the service is requested. For example, if a network printing service is offered, an offered paper size for the printing service may be accessed by a client requesting the service. In current systems, services advertise their presence on, for example, a name server, and passively wait for clients to decide to connect to the service. Therefore, a delay may occur in finding a desired service by a client as the client must actively pursue passive computer service hosts and multiple name servers may be contacted before a requested service is found to be offered by a host.

### SUMMARY OF THE INVENTION

In order to decrease any such delay in finding a desired computer service, and thereby create a better user experience where a user is provided with a desired service in a shorter amount of time as compared to prior art systems, one embodiment of the invention has been created which comprises an apparatus comprising a first computing device. The first computing device is configured to provide a service to one or more additional computing devices and advertise the service as available to the one or more additional computing devices by creating a data string relating to the first computing device location. The data string is adapted to enable the first computing device to actively solicit the service to the one or more additional computing devices. The first computing device is further adapted to advertise the service as available to the one or more additional computing devices by adding information associated with the service to the data string and providing the data string to the one or more additional computing devices prior to receiving a request to receive the service from the one or more additional computing devices.

Another embodiment of the invention comprises a computing system. In one computing system, prior to receiving a request at a first computing device for a computer service being offered by the first computing device, one computing system comprises a means of informing one or more computing devices that a computer service is being offered on the first computing device. The computing system further comprises a means for requesting the computer service upon being informed that the first computing device is offering the service, and a means for providing the computer service from the first computing device to the one or more computing devices.

And another embodiment of the invention comprises a method of using a first computing device to provide a service to at least one second computing device. In one method, prior to receiving a request for the service from the at least one second computing device, the first computing device sends to the at least one second computing device information related to the service. The method further comprises receiving the information related to the service at the at least one second computing device and sending a request for the service from the at least one second computing device to the first computing device. The method further comprises providing the service from the first computing device to the at least one second computing device.

Yet another embodiment of the invention comprises a non-transitory, tangible computer readable storage medium, encoded with processor readable instructions to perform a method of providing a computer service. One method comprises, prior to receiving a request for the service from at least one second computing device to a first computing device, sending from the first computing device to the at least one second computing device information related to the service. The method further comprises receiving the information related to the service at the at least one second computing device, sending a request for the service from the at least one second computing device to the first computing device, and providing the service from the first computing device to the at least one second computing device.

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

### BRIEF DESCRIPTION ON THE DRAWINGS

FIG. 1 illustrates a block diagram depicting components of a first computing device communicating with one or more additional computing devices;

FIG. 2 illustrates a block diagram of a computing system, depicting communications between system components;

FIG. 3 illustrates a flowchart that depicts a method that may be carried out in connection with the embodiments described herein; and

FIG. 4 illustrates a block diagram depicting components of a computing device.

### DETAILED DESCRIPTION

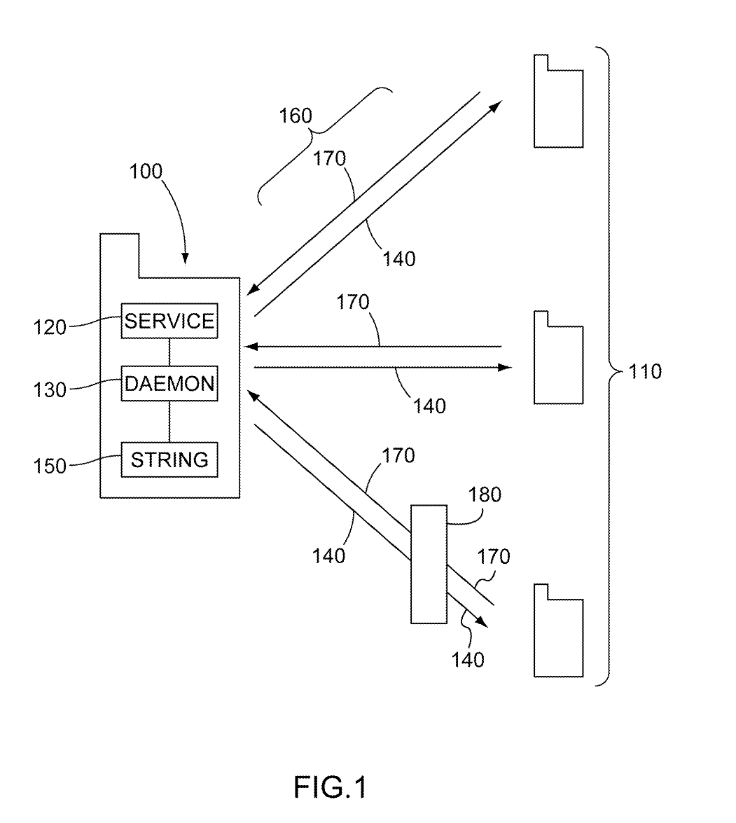

Referring first to FIG. 1, seen is an apparatus comprising a first computing device 100. The first computing device is adapted to provide a service 120 to one or more additional computing devices 110. The service 120 may comprise any computing device operation and may be related to an application associated with at least one of the one or more additional computing devices 110. For example, a “friend finder” application may be included on at least one of the one or more additional computing devices 110. The first computing device 100 may provide a service or otherwise provide information adapted to be used by the “friend finder” application. Other applications and services known in the art are contemplated. Furthermore, it is contemplated that the first computing device 100 and/or the one or more additional computing devices 110 may comprise either a server/host device or may comprise a client device such as, but not limited to, a wireless computing device. Additionally, the term application may refer to the computer-readable storage medium encoded with processor readable instructions described herein.

In one embodiment, the first computing device 100 may advertise the service 120 as available to the one or more additional computing devices 110 through a multicast name service. For example, a daemon process 130 running on the first computing device 110 may send an IP multicast message 140 using, for example IPv4 or IPv6 with UDP protocol. Other message types and protocols are contemplated. In one-such message 140, a link local address may be implemented and the daemon service 130 may send the message 140 across a reserved port number and multicast group. Furthermore, the daemon 130 in one embodiment may be adapted to send out such a message 140 at a predetermined frequency of time. For example, the daemon may run and may send the message 140 every 40 s. Such a period of time may be modified by a user through, for example, a user interface. As seen, the daemon process 130 may also be referred to herein as a daemon service and a daemon. The predetermined frequency of time may also be referred to as a time-based entry or a predetermined period of time. In one embodiment, the message 140 may be sent to a name server 180 which may then be used to send the message 140 to the one or more computing devices 110. A name server 180 may not be used in one or more embodiments and/or a computing device other than a name server 180 may receive the message 140 from the first computing device and/or send/relay the message 140 to the one or more additional computing devices 110. One or more name servers 180 and/or other devices may be involved in sending the message 180 to the one or more additional computing devices 110.

In one embodiment, a data string 150 may be created on the computing device 100, with the data string 150 being sent by the daemon 130 in the message 140. The data string 150 may comprise, for example, information relating to the location of the computing device 100 on a network 160 across which the message 140 may be sent from the computing device 100 to the one or more additional computing devices 110. The data string 150 may also comprise information associated with the service. For example, the data string may comprise information related to a specific feature of an application. Throughout the specification, when the term “data string” is used, the term may refer to the added information, where appropriate.

In a name server 180 environment that does not comprise the data string 150, the service 120 provided to the one or more additional computing devices 110 allows the one or more additional computing device 110 to identify the location of the service 120 via the location of the computing device 100. However, the data string 150 also conveys additional non-location information about the service 120 to the one or more additional computing devices 110. For example, information provided to the one or more additional computing devices 110 may describe the service 120 or otherwise inform the one or more additional computing devices 110 about one or more aspects of the service 120. Such a data string 120 may comprise a URL-encoded string.

For example, one service 120 may comprise a weather service, with the weather service being located at an IP address and port number of the computing device 100. In such an embodiment, the data string 120 may be sent to the name server 180, which may inform the one or more additional computing devices 110 that a weather event is occurring in a specified geographic region. Upon receiving the notice from the name server 180, the one or more additional computing devices 110 may accept the message 140 and display or otherwise utilize the information. Alternatively, with the friend-finder example, the service 120 may inform the one or more additional computing devices 110 that the last time a person registered with the service 120 was “x” time ago. If the one or more additional computing devices 110 last checked with the service at a time less than “x” time ago to determine whether any persons have registered, the one or more additional computing devices 110 may be updated that no additional checks are necessary since no new persons have registered. Therefore, by sending the message 140 to the one or more additional computing devices 110, less requests may be sent from the one or more additional computing devices 110. Such requests may operate similar to the response 170, 270, 275 communications described herein and may be adapted to update one or more features on the one or more additional computing devices 110. By sending fewer requests, fewer resources may be used on the one or more additional computing devices 110 and therefore, the one or more additional computing devices 110 and the services 120 may operate more efficiently.

In one embodiment, the data string 150 may be adapted to enable a first computing device comprising the computing device 100 to actively solicit a service being provided by the computing device 100 to the one or more additional computing devices 110. For example, the data string 150 may inform the one or more additional computing devices 110 that a “friend finder” service or a feature of the service (i.e. pictures of nearby friends) is being offered by the computing device 100. The one or more additional computing devices 110 may receive the message 140, and if the one or more additional computing devices 110 have a friend finder application installed on the one or more additional computing devices 110, the one or more additional computing devices 110 may send a response 170 to the computing device 100, requesting the service. A user of the one or more additional computing devices 110 may be prompted to send the response 170 or the one or more additional computing devices 110 may automatically send the response 170 to receive the service. Alternatively, if the one or more computing devices 110 do not have an application installed on the computing device 110 which is related to the message 140, the response 170 may be sent requesting to receive and/or install the application on the one or more computing device 110 and subsequently use the service provided by the computing device 100. Although FIG. 1 displays the message 140 and response 170 as a single message 140 and response 170, it is contemplated that multiple messages 140 and responses 170 may be sent between the computing device 100 and the one or more additional devices 110 to inform the one or more additional computing devices 110 of the service 120 and/or operate the service 120 on the one or more additional computing devices 110. As stated, within the data string of one such message 140 information may be included which is associated with the service, and the data string may be used by the one or more computing devices 110 to identify the service and the first computing device 100.

In one embodiment, the computing device 100 may comprise a first computing device which may comprise a server. Upon determining that the one or more additional computing devices 110 satisfy a one or more predetermined identifiers as set by the user prior to sending the message 140 (e.g., are located within a given geographic location, comprise a specific operating system, etc.), the first computing device 100 may then send the data string 150 to the one or more additional computing devices 110 in the message 140. In one embodiment, the predetermined identifiers may be received from the name server 180. One such data string 150 may comprise a URL-encoded string adapted to enable the one or more additional computing devices 110 to access the service provided by the server or another computing device comprising the first computing device 100 upon either manually selecting the string through, for example, touching the screen in a received and displayed message such as, but not limited to, a text-message, or automatically enable the string through, for example, a pre-installed computing application on the one or more computing devices 110, where the application may be enabled to automatically respond 170 to such messages 140 and/or otherwise obtain the services 120. In one embodiment, the service 120 may be provided by another first computing device 100 different than the first computing device 100 that sent the message 140.

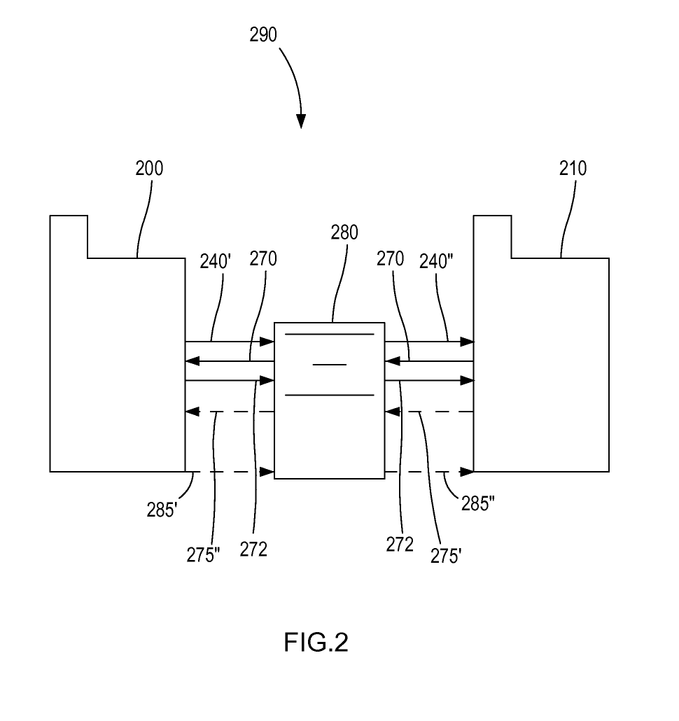

In one embodiment, one of the daemon process 130 and the data string 150 may be adapted to receive a time-based entry. For example, information associated with a time or a period of time may be included in the daemon 130 so that the daemon 130 runs at a specified frequency of, for example, every 40 seconds. Alternatively similar information may be included in the data string 150 so that a name server 180 actively solicits the service 120 to the one or more additional computing devices 110 at a similar frequency. For example, seen in FIG. 2 is one name server 280 which may receive the message 240′ from the first computing device 200 send the message 240″ to the one or more additional computing devices 210. The name server 280 may apply the predetermined identifiers as set by the user of the device 200 and based on those identifiers, determine which of the one or more additional computing devices 210 to send the message 240″ to. Upon making this determination, the message 240″ is sent to the device 210.

In the FIG. 2 computing system 290, the name server 280 is used to inform the one or more computing devices 210 that that a computer service is being offered on the first computing device 200 prior to receiving a request 175 at the first computing device 200 for the computer service from the one or more computing devices 210. For example, in the prior art, the one or more computing devices 210 may become aware of the service being offered by the first computing device 200 through issuing the request 275′ for the service. In such an embodiment, the request 275′ may be analyzed by the name server 280 and then sent to the first computing device 200, as the name server 280 or request 275″ may identify the first computing device 200 as providing the requested service. Upon receiving the request 275″, the first computing device 200 would then provide one or more response messages 285′, 285″ to the name server 280 and/or directly to the one or more additional computing devices 210 to provide the requested service.

As opposed to the prior art request 275 and response 285 described above in which the first computing device 200 passively waits for the request 275 before providing the service in the response 285, in issuing the message 240′ from the first computing device 200 to the one or more additional computing devices 210 before receiving the request 275, the first computing device 200 is actively soliciting the service or services provided by the first computing device 200 to the one or more additional computing devices 210. In such a manner, the one or more additional computing devices 210 may obtain the service provided by the computing device 200 more quickly than with the prior art request 275 and response 285.

Computing structures known in the art and described herein to provide the message 240, receive the response 270, and provide the requested service(s) are contemplated. Multiple services may be offered and/or requested in the messages 240, 270 described above or in other messages described herein. Furthermore, one means of informing one or more computing devices 210 that a service is being offered on a first computing device 200 is the message 240 described above with reference to FIGS. 1 and 2. In one embodiment, a means for requesting the computer service may comprise the response 270. Furthermore, a means for providing the computer service from the first computing device to the one or more computing devices 210 may comprise a service providing message 272.

In one embodiment, a means of informing the one or more additional computing devices 210 of the service being offered by the first computing device 200 may comprise the system, devices, and messages described in reference to FIGS. 1 and 2. In one such embodiment, the message 240 may be sent to the one or more additional devices 210 a predetermined time-based frequency. For example, the names server 280 and/or the first computing device 200 may inform the one or more computing devices 210 at a frequency of, for example, 40 seconds, that the service is being offered. In one embodiment, the predetermined time-based frequency comprises a time-based frequency set by a user.

Means of informing one or more computing devices that a computer service is being offered on the first computing device 200 prior to receiving a request 275 at the first computing device 200 for the computer service from the one or more computing devices 210 may comprise using the demon 130 at the first computing device 100 to provide the one or more computing devices 110 with a URL-encoded string, as disclosed above with reference to FIG. 1. In one embodiment, the URL-encoded string may be adapted to inform the one or more computing devices 110 that the first computing device 100 offers a service the one or more computing devices 110 are aware of. For example, a registry entry on the one or more additional computing device 110 may identify the service relating to an application installed on the one or more computing device 110. Also, and as seen in FIG. 1, the first computing device 100 may be different from the one or more computing devices 110.

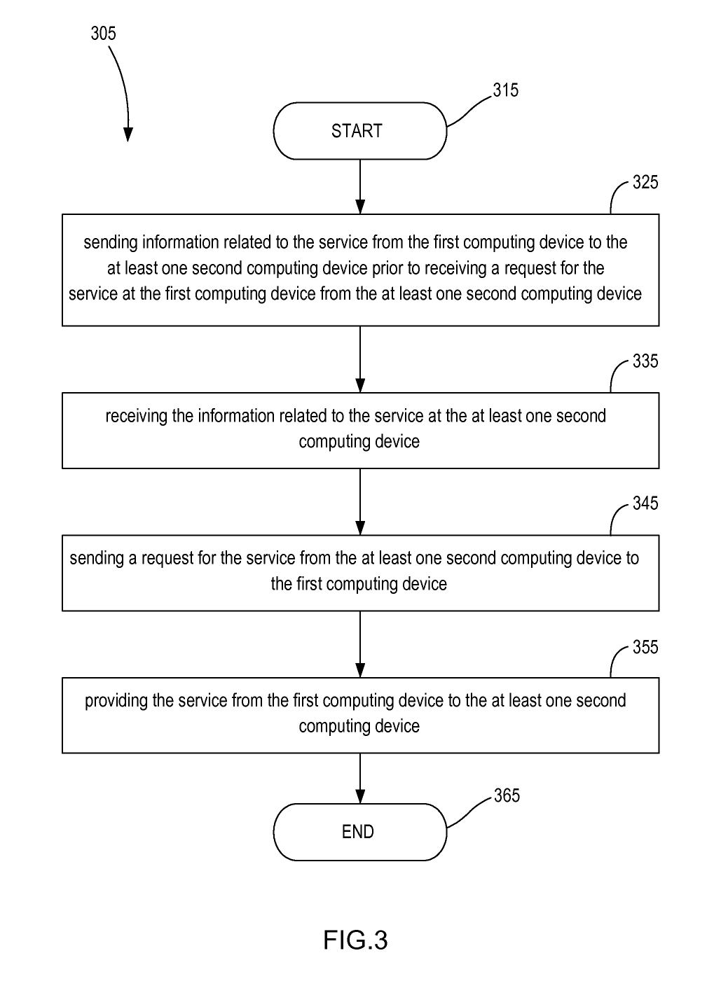

Turning now to FIG. 3, seen is a method 305 of using a first computing device to provide a service to at least one second computing device. The first computing device may comprise the first computing device 100, 200 seen in FIGS. 1 and 2 and the at least one second computing device may comprise at least one of the one or more computing devices 110, 210 seen in FIGS. 1 and 2. One method starts at 315. At 325 the method 305 comprises sending information related to the service from the first computing device 100 to the at least one second computing device 210 prior to receiving at the at least first computing device 100 a request for the service from the at least one second computing device 210. As discussed with reference the FIGS. 1 and 2, a message 140, 240 may be sent from the first computing device 100, 200 to the one or more additional computing devices 110, 210 before a request 275 is sent or received, with the message 140 comprising information related to the service provided by the first computing device 100.

At 335 the method 305 comprises receiving the information related to the service at the at least one second computing device 210. For example, the at least one second computing device 210 may receive the information in accordance with the description of FIGS. 1 and 2, above. At 345 the method 305 comprises sending a request for the service from the at least one second computing device 210 to the first computing device 100. For example, upon receiving the message 140, as seen in FIG. 1 and discussed above, the at least one second computing device 110 may send the response 170, which may request the services identified in the message. At 355, the method 305 comprises providing the service from the first computing device to the at least one second computing device. For example, as seen in FIG. 2, upon receiving the response 270, the first computing device 200 may provide the service in the service providing message 272. For ease of use, only a single message 140, response 170, and service providing message 272 are shown in FIGS. 1 and 2. However, each of the message 140, response 170, and service providing message 272 may comprise multiple communications between the devices shown in FIGS. 1 and 2. The method 305 ends at 365.

One method 305 may further comprise creating the information related to the service prior to the step 325 of sending information related to the service from the first computing device 100 to the at least one second computing device 210. For example, the daemon 130 may automatically create the information within the message 140, or a user may manually enter the data within the message 140. Creating the information related to the service may further comprise including the information within a URL-encoded string 150. In one embodiment, the information references at least one service identifiable to the at least one second computing device 110.

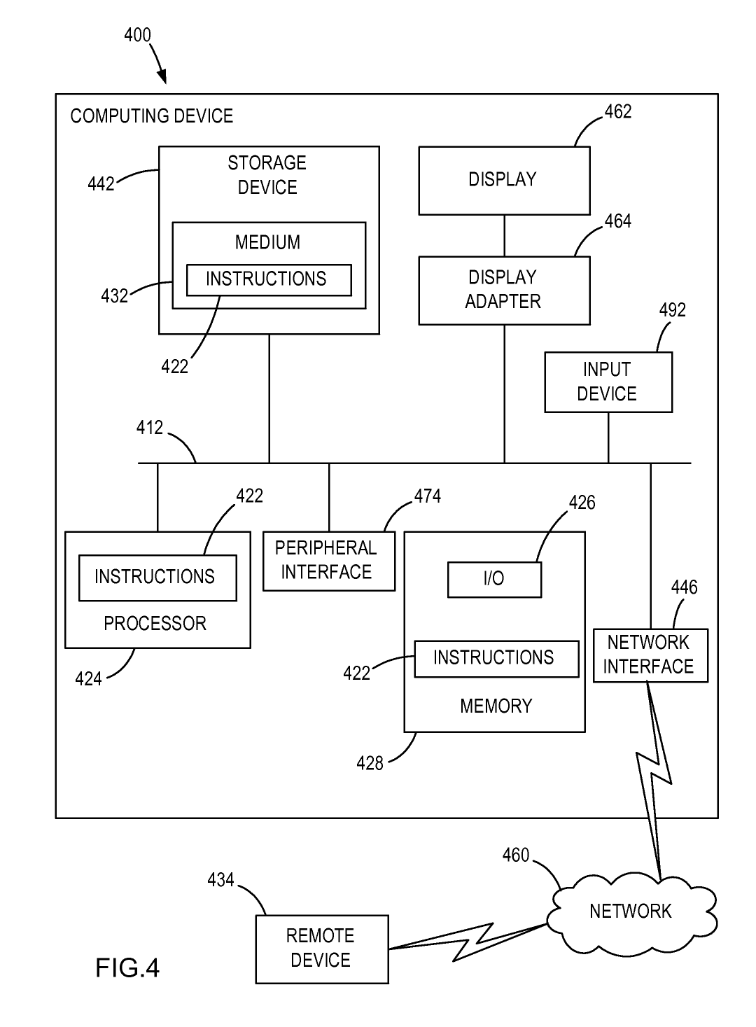

One embodiment of the invention comprises a non-transitory, tangible computer readable storage medium, encoded with processor readable instructions to perform a method of providing a computer service. For example, seen in FIG. 4 is one example of a storage medium 432. One such method may comprise sending from the first computing device 100 seen in FIG. 1 to the at least one second computing device 110 seen in FIG. 1, information related to the service, prior to receiving the request 275 for the service from the at least one second computing device 210, as seen in FIG. 2. One or more storage mediums 432 may be further adapted to receive the information related to the service at the at least one second computing device 210 and send a request such as, but not limited, to, the response 170 for the service from the at least one second computing device 110 to the first computing device 100. A medium 432 may be further adapted to provide the service from the first computing device 100 to the at least one second computing device 110.

The method performed by the non-transitory, tangible computer readable storage medium 432 may further comprise creating the information related to the service prior to sending the message 140. In one embodiment, creating the information related to the service comprises adding the information to a URL-encoded string. Furthermore, the information may reference at least one service that is identifiable to the at least one second computing device 110. For example, the at least one second computing device 210 may comprise an application stored in or on the medium 432, with the application being related to the information in the message 140. Additionally, a name server 180 may be involved in at least one of receiving the information related to the service at the at least one second computing device 110 and sending a request 170 for the service from the at least one second computing device 110 to the first computing device 100.

FIG. 4 shows a diagrammatic representation of one embodiment of a machine in the exemplary form of the computing device 400, 100 and/or the one or more additional computing devices 110, 210, within which a set of instructions for causing a device to perform any one or more of the aspects and/or methodologies of the present disclosure to be executed. Computing device 400 includes a processor 424, which communicates with the memory 428 and with other components, via the bus 412. Bus 412 may include any of several types of bus structures including, but not limited to, a memory bus, a memory controller, a peripheral bus, a local bus, and any combinations thereof, using any of a variety of bus architectures.

Memory 428 and/or the storage device 442 may include various components (e.g., machine readable media) including, but not limited to, a random access memory component (e.g., a static RAM “SRAM”, a dynamic RAM “DRAM, etc.), a read only component, and any combinations thereof. In one example, a basic input/output system 426 (BIOS), including basic routines that help to transfer information between elements within computing device 400, such as during start-up, may be stored in memory 428. Memory 428 and/or the storage device 442 may also include (e.g., stored on one or more machine-readable media) instructions (e.g., software) 422 which may comprise the service 120, daemon 130, and/or string 150 seen in FIG. 1, the instructions 422 embodying any one or more of the aspects and/or methodologies of the present disclosure. In another example, memory 428 and/or the storage device 442 may further include any number of program modules including, but not limited to, an operating system, one or more application programs, other program modules, program data, and any combinations thereof.

Computing device 400 may also include the storage device 442. Examples of a storage device (e.g., storage device 442) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 442 may be connected to bus 412 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 442 may be removably interfaced with computing device 400 (e.g., via an external port connector (not shown)). Particularly, storage device 442 and an associated machine-readable medium 432 may provide nonvolatile and/or volatile storage of machine-readable instructions, data structures, program modules, and/or other data for computing device 400. In one example, instructions 422 may reside, completely or partially, within machine-readable medium 432. In another example, instructions 422 may reside, completely or partially, within processor 424.

Computing device 400 may also include an input device 492. In one example, a user of computing device 400 may enter commands and/or other information into computing device 400 via input device 492. Examples of an input device 492 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 492 may be interfaced to bus 412 via any of a variety of interfaces (not shown) including, but not limited to, a serial interface, a parallel interface, a game port, a USB interface, a FIREWIRE interface, a direct interface to bus 412, and any combinations thereof.

A user may also input commands and/or other information to computing device 400 via storage device 442 (e.g., a removable disk drive, a flash drive, etc.) and/or a network interface device 446 which may comprise a transmitter/receiver. In one embodiment, the transmitter/receiver comprises a wireless transmitter/receiver. A network interface device, such as network interface device 446 may be utilized for connecting computing device 400 to one or more of a variety of networks, such as network 460, and one or more remote devices 434 connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 460, may employ a wired and/or a wireless mode of communication. In general, any network topology may be used. Information (e.g., data, software, etc.) may be communicated to and/or from computing device 400 via network interface device 446.

Computing device 400 may further include a video display adapter 464 for communicating a displayable image to a display device, such as display device 462. Examples of a display device include, but are not limited to, a liquid crystal display (LCD), a cathode ray tube (CRT), a plasma display, and any combinations thereof. In addition to a display device, a computing device 400 may include one or more other peripheral output devices including, but not limited to, an audio speaker, a printer, and any combinations thereof. Such peripheral output devices may be connected to bus 412 via a peripheral interface 474. Examples of a peripheral interface include, but are not limited to, a serial port, a USB connection, a FIREWIRE connection, a parallel connection, and any combinations thereof. In one example an audio device may provide audio related to data of computing device 400 (e.g., data representing an indicator related to pollution impact and/or pollution offset attributable to a consumer).

A digitizer (not shown) and an accompanying stylus, if needed, may be included in order to digitally capture freehand input. A pen digitizer may be separately configured or coextensive with a display area of display device 462. Accordingly, a digitizer may be integrated with display device 462, or may exist as a separate device overlaying or otherwise appended to display device 462.

In conclusion, embodiments of the present invention provide for advertising computer services. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. An apparatus comprising a first computing device, wherein the first computing device is configured to:
provide a service to one or more additional computing devices; and
advertise the service as available to the one or more additional computing devices including:
a creation of a data string relating to a location of the first computing device, wherein, the data string is adapted to enable the first computing device to actively solicit the service to the one or more additional computing devices prior to receiving at the first computing device a request for the service from the one or more additional computing devices;
adding information associated with the service to the data string; and
providing the data string to the one or more additional computing devices.

2. The apparatus of claim 1, wherein the first computing device comprises a server.

3. The apparatus of claim 1, wherein, the data string comprises a URL-encoded string.

4. The apparatus of claim 1, wherein:
the data string comprises a time-based entry; and
the time-based entry is associated with a frequency that the first computing device actively solicits the one or more additional computing devices.

5. The apparatus of claim 1, wherein the data string is provided to the one or more additional computing devices using a name server.

6. A computing system comprising:
means of informing one or more computing devices that a computer service is being offered on a first computing device prior to receiving a request at the first computing device for the computer service from the one or more computing devices;
means for requesting the computer service; and
means for providing the computer service from the first computing device to the one or more computing devices.

7. The computing system of claim 6, wherein the means of informing one or more computing devices that a computer service is being offered on a first computing device prior to receiving a request at the first computing device for the computer service from the one or more computing devices comprises a means of informing the one or more computing devices at a predetermined time-based frequency that a computer service is being offered.

8. The computing system of claim 7, wherein the predetermined time-based frequency comprises a time-based frequency set by a user.

9. The computing system of claim 6, wherein the means of informing one or more computing devices that a computer service is being offered on a first computing device prior to receiving a request at the first computing device for the computer service from the one or more computing devices comprises, using a demon at the first computing device to automatically provide the one or more computing devices with a URL-encoded string.

10. The computing system of claim 9, wherein the URL-encoded string is adapted to inform the one or more computing devices that the first computing device offers a service the one or more computing devices are aware of.

11. The computing system of claim 10 wherein, the one or more computing devices are aware of the service when an application on the one or more computing devices are adapted to process information related to the URL-encoded string.

12. The computing system of claim 6, wherein the first computing device is different from the one or more computing devices.

13. A method of using a first computing device to provide a service to at least one second computing device comprising:
sending information related to the service from the first computing device to the at least one second computing device prior to receiving a request for the service at the first computing device from the at least one second computing device;
receiving the information related to the service at the at least one second computing device;
sending a request for the service from the at least one second computing device to the first computing device; and
providing the service from the first computing device to the at least one second computing device.

14. The method of claim 13, further comprising creating the information related to the service prior to sending information related to the service from the first computing device to the at least one second computing device.

15. The method of claim 14, wherein creating the information related to the service comprises one of adding the information to a URL-encoded string and creating the URL-encoded string comprising the information.

16. The method of the claim 14, wherein the information references at least one service identifiable to the at least one second computing device.

17. A non-transitory, tangible computer readable storage medium, encoded with processor readable instructions to perform a method of providing a computer service, the method comprising:
prior to receiving a request for the service from the at least one second computing device, sending information related to the service from the first computing device to the at least one second computing device;
receiving the information at the at least one second computing device;
sending a request for the service from the at least one second computing device to the first computing device; and
providing the service from the first computing device to the at least one second computing device.

18. The non-transitory, tangible computer readable storage medium of claim 17 further comprising creating the information related to the service prior to sending the information related to the service from the first computing device to the at least one second computing device; and wherein, the information is further related to an application identifiable by the second computing device.

19. The non-transitory, tangible computer readable storage medium of claim 18 wherein, creating the information related to the service comprises one of adding the information to a URL-encoded string and creating the URL-encoded string comprising the information.

20. The non-transitory, tangible computer readable storage medium of claim 17 wherein, the information references at least one service identifiable to the at least one second computing device.

21. The non-transitory, tangible computer readable storage medium of claim 16 wherein, a name server is involved in at least one of receiving the information related to the service at the at least one second computing device and sending a request for the service from the at least one second computing device to the first computing device.
